(19) United States
(12) Patent Application Publication
(10) Pub. No.: US 2011/0198448 A1
(43) Pub. Date: Aug. 18, 2011

(54) LINKAGE ASSEMBLY FOR OPERATIVELY CONNECTING A BLUE FLAG TO A DERAIL

(76) Inventor: Mark T. Allement, Baton Rouge, LA (US)

(21) Appl. No.: 12/845,201

(22) Filed: Jul. 28, 2010

Related U.S. Application Data
(60) Provisional application No. 61/304,740, filed on Feb. 15, 2010.

(51) Int. Cl. B61K 5/06; G05G 1/00

(52) U.S. Cl. 246/163; 74/469

(57) ABSTRACT

An improved linkage assembly for operatively connecting a derail to a blue flag assembly to cause the blue flag assembly to be raised from a horizontal position between train track rails to a vertical position substantially perpendicular to the train track when the derail is manipulated into an operative mode for derailing a train, train car or similar type wheeled vehicle, and further provided with a stop device to inhibit accidental raising of the blue flag assembly until it is desired to do so. The linkage assembly is constructed having a support plate also mountable on adjacent cross ties, and further includes a blue flag mounting assembly to permit the blue flag signal to pivot between horizontal and vertical positions. The linkage assembly further including a spring loaded tensioning device attached at one end to the blue flag mounting assembly and attached at its opposite end to a cam assembly also mounted on the support plate. The cam assembly is operatively connected to a linkage arm which in turn is connected to the derail whereby the manipulation of the derail from its non-operative position to its operative, derailing position causes the blue flag signal to be pivoted from the horizontal to the vertical position and which locks out any change in the derail position by manipulation of the blue flag signal.

### BACKGROUND OF THE INVENTION

1. Field of the Invention

This invention relates to an improved derail with connected blue flag signal, and more particularly to an improved linkage to operatively connect the blue flag signal to the derail.

2. Prior Art

Derails and blue flag signals are each safety devices widely used on railroads. A derail is a device placed on a track rail for derailing and thus effectively stopping a train or unattended rolling stock, such as a railway car, which rolls over or through the derail.

Train derails are commonly positioned where sidings meet main lines or other tracks, at junctions or other crossings to protect the interlocking against unauthorized movement, and at areas wherein railroad personnel are working on a rail line. Derails may be portable or may be permanently installed on the rail, and come in different shapes, sizes and weights. Both types of derails are commonly used with blue flag signals. A blue flag signal as the term is used in the railroad industry and in the present specification and claims is a signal used on railroad track to protect humans working on or about the track and to protect equipment on the track. Originally, the blue flag signal was a blue flag mounted on a staff or pole where it could be easily seen by the train engineer from his position in a locomotive engine cab. Today, the blue flag signal includes any type of flag or signage that is positioned on a staff located at the desired position, such as adjacent the train track or more preferably between the rails of the train track.

It is known to operatively link the blue flag signal to the derail so that manipulating the derail from its non-operative position to its operative or derailing position causes the blue flag signal to pivot upward from a horizontal position below and between the top of the train track rails to a vertical position whereby the flag or signage is clearly visible. Examples of such prior art devices are illustrated in U.S. Pat. Nos. 1,439,086; 3,517,186; and 3,544,960. Despite the many years of usage there remain significant problems in linking the operation of the derail to the movement of the blue flag signal.

One serious safety problem is that unintentional striking of the blue flag signal can result in an unintended change in the derail position from its derailing position to its non-operative position. This can occur when a railroad employee inadvertently hits the blue flag signal, when a locomotive or other moving stock strikes the blue flag signal, or when extreme winds strike the blue flag signal. In these circumstances the purpose of the derail is defeated and exposes workmen and/or other equipment on the train track to injury from the failure to derail a train.

Another problem results from the manual manipulation of the derail. The action of manipulating the derail shoe from one position to the next causes the blue flag signal to strike the railroad cross ties or debris that may be located between the train track rails which over time results in bending and other damage to the blue flag signal. If the blue flag signal becomes sufficiently bent then even in the vertical position it will not be clearly visible to an approaching train.

Still another problem results in the corrosion of the metal around the pivoting members of the linkage resulting from long term contact with rain water and other fluids collecting in the various parts of the prior art linkage. This can result in damage to the linkage and the blue flag signal. Also if the derail is not used often the linkage can become inoperative because the connecting members become frozen in place due to the corrosion.

Still another problem results from damage to the blue flag signal during the derailing process. Even in the non-operative position the blue flag signal can become damaged as a train passes over the signal as a result of debris that is snagged to the underside of the train. It would be desirable to minimize this damage and to construct the linkage for easy and quick repair.

A still further problem can result when the derail is accidentally manipulated to place the derail assembly from a non-derailing position to a derailing position. It would be desirable to prohibit or inhibit such accidental manipulation to avoid unintentional derailing of the train.

### OBJECTS AND SUMMARY OF THE INVENTION

Therefore, one object of this invention is to provide reliable operative connection between the derail and its corresponding blue flag signal.

Another object of this invention is to provide improved linkage between a blue flag signal and a derail that prevents contact or manipulation of the blue flag signal from inadvertently changing the position of the derail.

A further object of this invention is to prevent or minimize the damage to the blue flag signal resulting from manipulation of the derail.

A still further object of this invention is to prevent the accidental movement of the derail to a non-operative position through the inadvertent contact with the blue flag signal or staff.

A still further object of this invention is to prevent the accidental movement of the derail to an operative derail position through inadvertent movement of the derail or the blue flag signal.

Another object of this invention is to provide linkage constructed to minimize corrosion of its parts due to weather and other environmental factors. Still another object of this invention is to provide an improved linkage between a blue flag assembly and a derail assembly that is easily repairable and/or at a lower cost when damaged.

Other objects and advantages of this invention shall become apparent from the ensuing descriptions of the invention.

Accordingly, an improved linkage assembly operatively connecting a blue flag signal to a derail comprises a support plate sized to mount between the parallel rails and be attached to two adjacent cross ties of the train track. The linkage assembly further comprises a blue flag mounting assembly to which the blue flag signal is operatively attached for movement between a horizontal and a vertical position. The blue flag mounting assembly includes a shaft extending through the center passageway of a metal sleeve that is affixed to the support plate. The metal sleeve is provided with a grease fitting to permit grease to be inserted into the passageway. The shaft is milled to machine tolerance to permit the inserted grease to be positioned between the shaft and the sleeve to allow the shaft to easily rotate within the sleeve and to prevent or minimize any corrosion to the shaft and the interior surface of the metal sleeve. The shaft has a flange at one end which abuts against one end of the sleeve to prevent the shaft from being pushed through the passageway. The shaft is of sufficient length so that its opposite end extends sufficiently beyond the sleeve to provide a rotating surface to which the blue flag staff can be affixed to permit the blue flag to pivot between the horizontal and vertical positions when the shaft is rotated. To limit the degree of rotation a pivot control arm is fixed to the rotating shaft adjacent the blue flag staff. A stop block is affixed to the support place to be positioned in the path of the pivot control arm to prevent the blue flag staff from rotating from the horizontal position past the vertical position. The linkage assembly also includes a spring loaded tensioning device operatively connected to a cam assembly which in turn is operatively connected to a linkage arm. To complete the linkage between the blue flag signal and the derail, the spring loaded tension device is operatively attached to the pivot control arm and the linkage arm is operatively attached to the derail so that the manipulation of the derail between the operative, derailing position to the non-operative position causes the blue flag signal to move from its vertical position to its horizontal position, and vice versa.

In a preferred embodiment the spring loaded tension device is constructed so that a “lock out” force is applied against the pivot control arm and the derail through the cam assembly and linkage arm connection to prevent the blue flag signal from moving from the vertical position to the horizontal position unless the derail has been manipulated to move from the operative, derailing position to the non-operative position. The tension device includes a main cylinder having a cavity wherein one end of the cavity is closed by a ball joint assembly. A spring is inserted into the cylinder whereby one end of the spring contacts the cylinder closed end. A piston shaft is partially inserted into the cylinder until it contacts the opposite end of the spring. Affixed perpendicular to the piston shaft surface is a roll pin that fits into a slot contained in the cylinder wall. The slot is positioned so that the insertion of the roll pin causes a compression of spring resulting in a force being applied to the piston shaft. The length of the slot is set to limit the amount of spring compression. The piston shaft is provided with another ball joint assembly that is affixed to the pivot control arm, thus the force of the spring on the piston is transferred to the pivot control arm. The “lock out” feature is further obtained by the construction of the cam assembly and the linkage arm. The cam assembly includes an upper and lower cam plates positioned on opposite sides of the support plate and supported by a tubular sleeve that extends through an opening in the support plate. The upper and lower cam plates are affixed to one another by a solid rod that extends though the tubular sleeve and is sized to rotate about the vertical axis of the tubular sleeve. To obtain the desired linkage and the “lock out” feature the angle formed by the solid rod and the two cam plates is set between 95° and 120°, more preferably at about 105°. To further enhance the “lock out” feature the linkage arm is shaped to prevent the release of the “lock out” until the derail shoe has been pivoted upward at least 45° from its derailing position. A preferred shape is to position the connection of the linkage arm to the bottom cam plate below the connection position of linkage arm and the derail. The linkage arm is then bent upward to position its end at the connection position. It is preferred that the bend in the linkage arm be about 90°. This combination of features results in the breakage of one of the linkage elements before the derail is moved from its derailing position to its non-operative position. In another preferred embodiment a blue flag staff lock-out device having a spring loaded latching means is affixed to the support plate at a position to place the latching means in the path of the staff as it moves from vertical to horizontal positions, and vice versa. The latching means is constructed to move to a non-locking position by contact with the blue flag staff during its vertical to horizontal movement, and then to automatically move to a locking position once the blue flag staff has passed below the latching means.

### BRIEF DESCRIPTION OF THE DRAWINGS

The accompanying drawings illustrate preferred embodiments of this invention. However, it is to be understood that these embodiments are not intended to be exhaustive, nor limiting of the invention. They are only examples of the linkage that can be used to operatively connect a blue flag signal to a derail.

FIG. 1 is a three-quarter perspective view of a preferred embodiment of the invention with the derail in operative position to derail a train or train car.

FIG. 2 is a three-quarter perspective view of a preferred embodiment of the invention with the derail in an inoperative position to allow a train or train car to pass without derailing

FIG. 3 is a three-quarter perspective view of the cam assembly of a preferred embodiment of the invention.

FIG. 4 is a cross-sectional view of a preferred embodiment of the blue flag mounting structure.

FIG. 5 is a cross-sectional view of a preferred embodiment of the tensioning assembly.

FIG. 6 is an exploded view of a preferred embodiment of the extending end of the main cylinder of the tensioning assembly.

FIG. 7 is a three-quarter perspective view of a preferred embodiment of the linkage bar.

FIG. 8 is a side view of a preferred embodiment of the tensioning assembly.

FIG. 9 is a three-quarter perspective view of a preferred embodiment of the lock-out device of the invention.

FIG. 10 is a cross-section view of the lock-out device taken along lines A-A of FIG. 9.

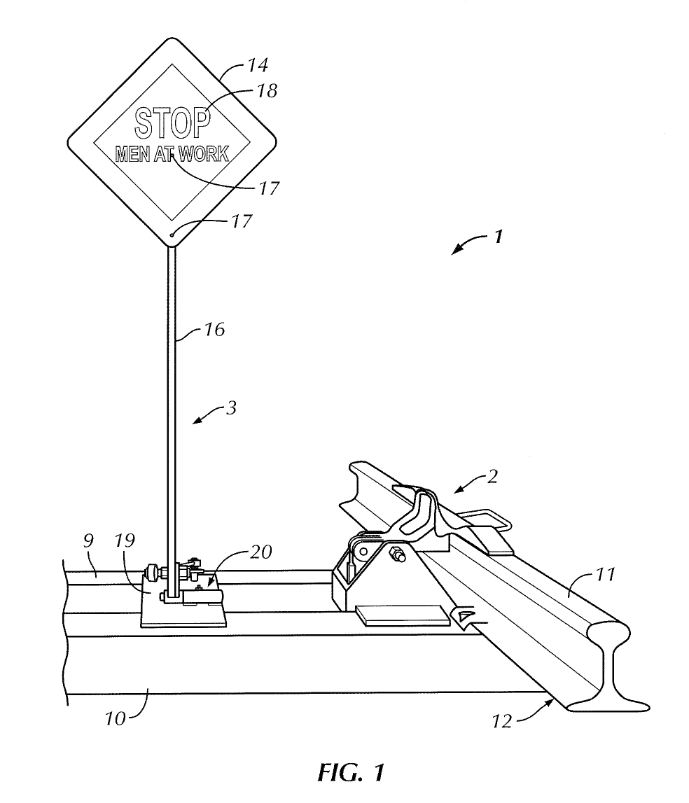

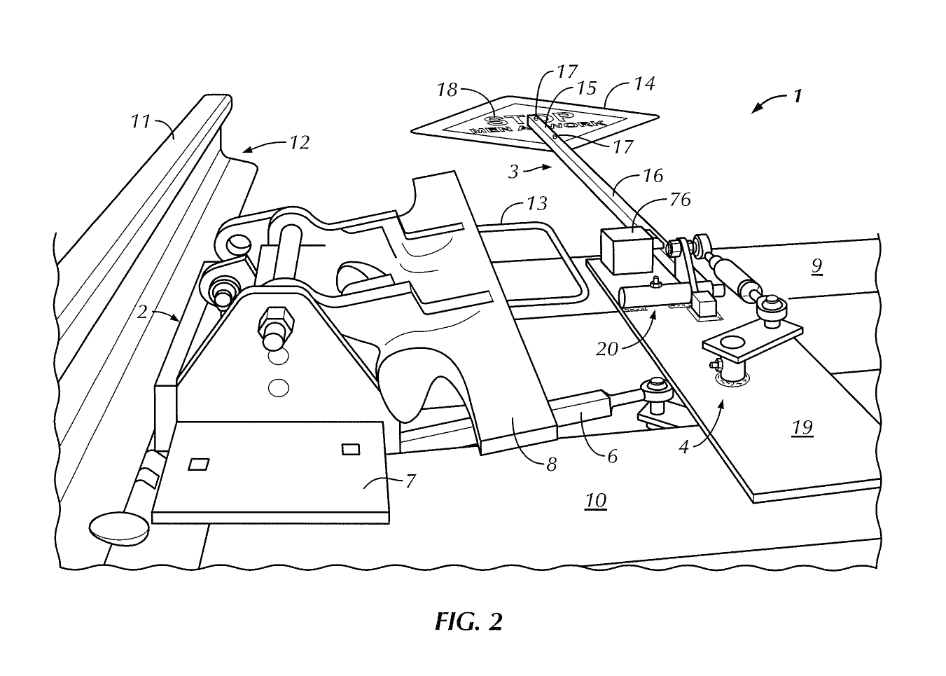

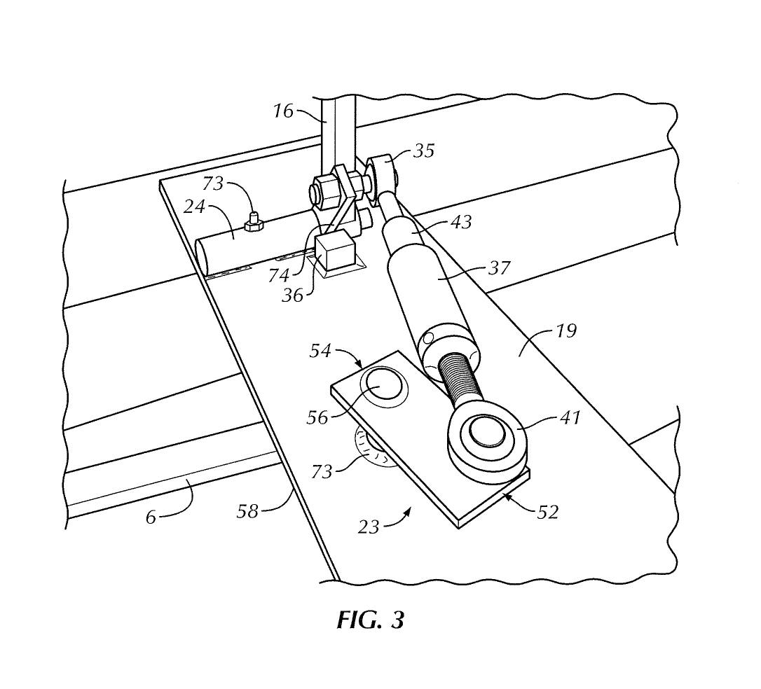

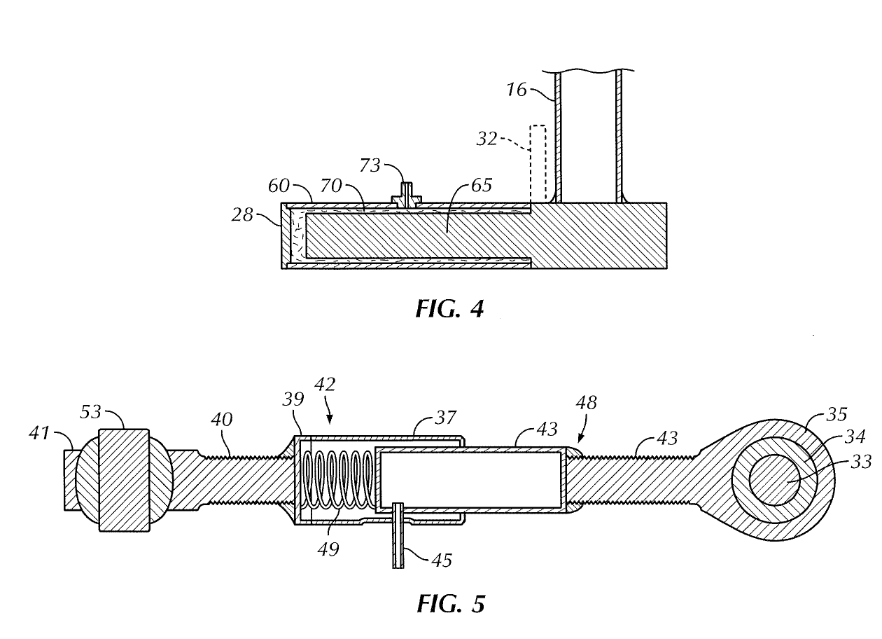

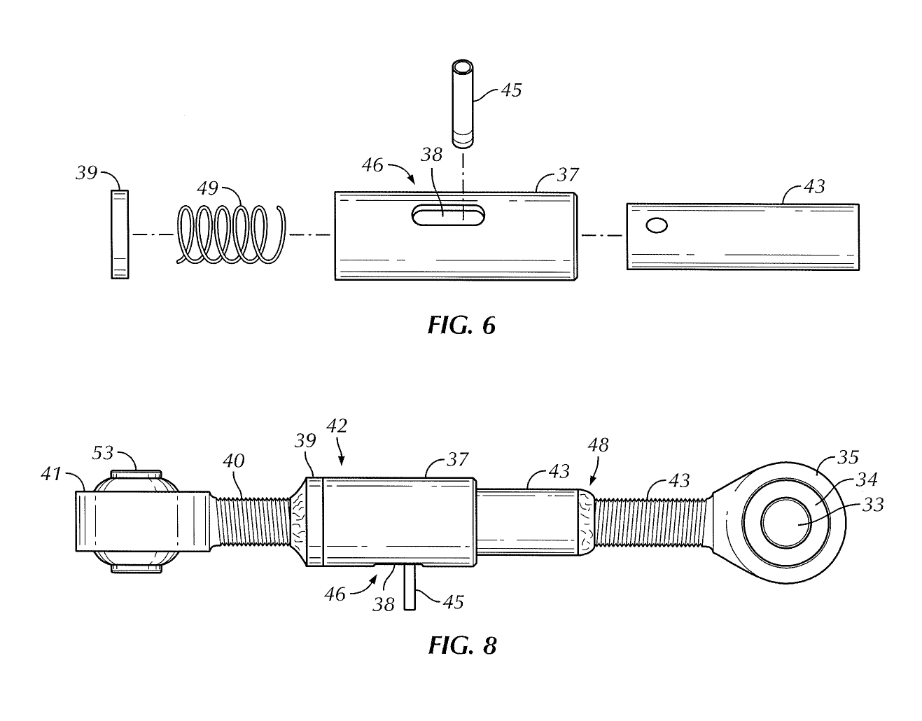

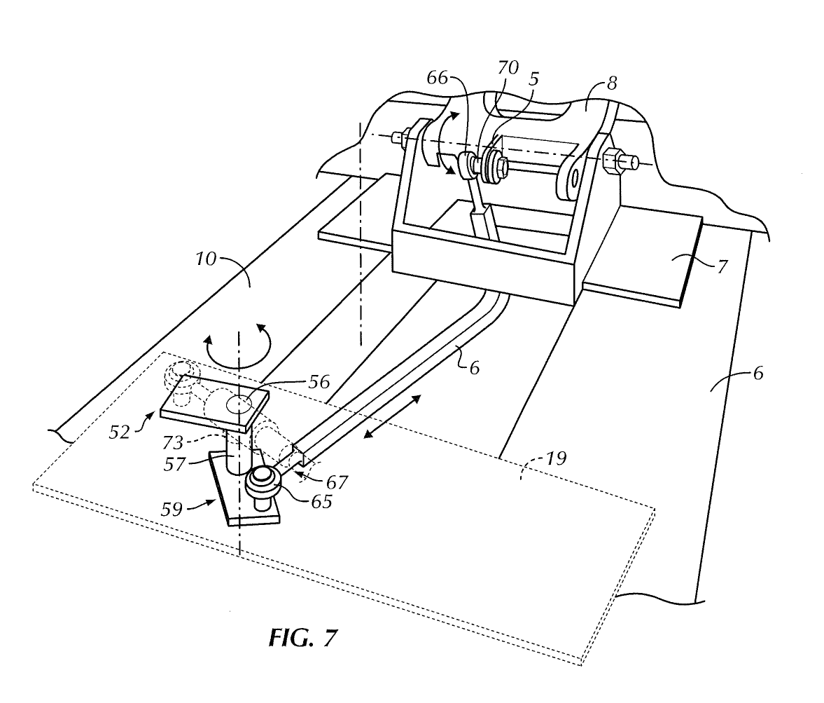

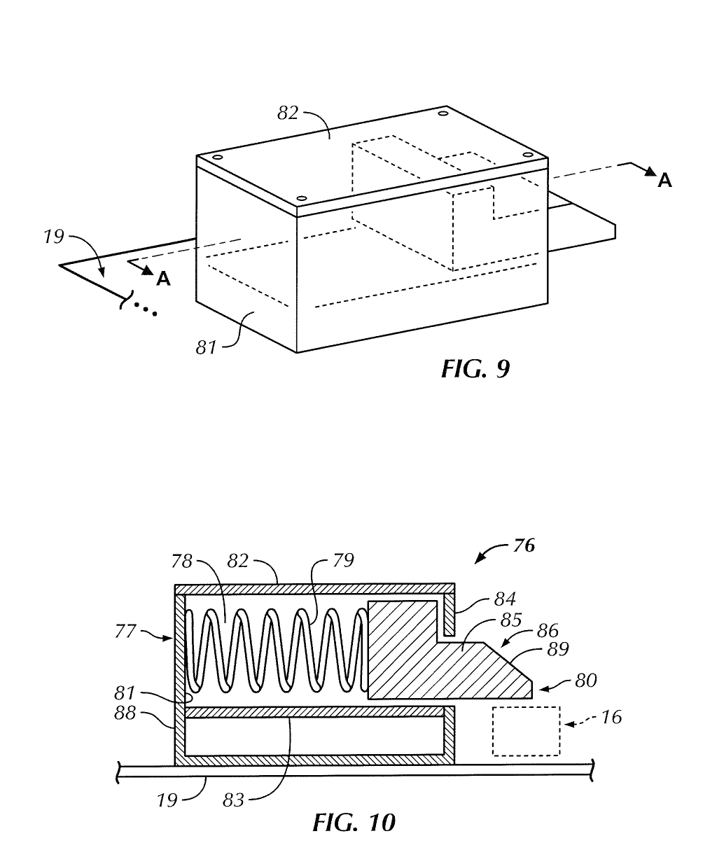

### PREFERRED EMBODIMENTS OF THE INVENTION

Without any intent to limit the scope of this invention, reference is made to the photographs and figures in describing the preferred embodiments of the invention.

Referring now to Photograph Nos. 1-4 a preferred embodiment of the derail-blue flag signal assembly 1 is illustrated. Assembly 1 comprises three basic elements: a derail 2, a blue flag signal 3 and a linkage assembly 4. This invention can be constructed using either portable or permanently mounted derails. The one illustrated in the photographs is an older model manufactured by The Nolan Company located in Canton, Ohio. Derail 2 includes a base 7 and a derail shoe 8 that is pivotally attached to base 7 to permit it to be moved between an operative, de-railing position and an inoperative position as illustrated in Photographs 1-4. If the derail does not have an attachment member 5 to which linkage bar 6 can be operatively connected by a ball and socket coupling, then the derail shoe 8 must be modified to provide the attachment member 5. The derail 2 illustrated has been modified by welding an attachment member or ear 5 to the derail shoe 8 to which the linkage bar 6 can be operatively attached. The base 7 is sized to be mounted on adjacent rail road cross ties 9 and 10 and positioned to permit the derail shoe 8 to be positioned across the top surface 11 of rail 12 for derailing the train, moving stock or similar wheeled vehicle moving on the train tracks. In the manually operated derails the derail shoe 8 will be provided with an activation handle 13 that a human operator can grasp to lift the derail shoe 8 into and out of its operative position. The operation of these type derails is well known in the art.

The blue flag signal 3 includes a flag or sign 14 that is affixed to the top end section 15 of signal staff 16 by bolts 17 or by such other known means including welding. Sign 14 can include various warning symbols or words 18 and can be in the traditional blue color or in any other color or color combinations desired.

The linkage assembly 4 includes a metal support plate 19 that is sized to be affixed to the adjacent cross ties 10 and 11 by bolts, tie nails or other known attaching devices. Blue flag signal 3 is pivotally mounted to support plate 19. This mounting can be achieved by any number of well known pivot mounting type structures. However, it is preferred that the pivot mounting structure used have a stop device that restricts the blue flag signal 3 from pivoting from the horizontal position to beyond the vertical position. Photographs 5-7 illustrate a preferred pivot mounting structure. In this structure a blue flag staff mounting structure 20 and a linkage assembly 21 including a tensioning assembly 22 and a cam assembly 23 are mounted to support plate 19. The staff pivot mounting structure 20 includes a metal tubular member or sleeve 24 affixed, such as by welding, to the top surface 25 of support plate 19. As shown in Sketch 1, the sleeve 24 has a passageway 26 extending through sleeve 24 along the sleeve's center axis “A”. The mounting structure 20 also includes a shaft 27 inserted into passageway 26 extending along the center axis of sleeve 24. Shaft 27 is provided with a flange 28 at one end. Flange 28 is sized so that it abuts against sleeve end 29 forming a seal of the passageway 26 at sleeve end 29 to prevent or minimize water from entering passageway 26. Shaft 27 is of sufficient length so that its opposite end section 30 extends sufficiently beyond sleeve 24 to provide a rotating surface 31 to which blue flag staff 16 can be affixed to permit the blue flag signal 3 to pivot between the horizontal and vertical positions when shaft 27 is rotated. Blue flag staff 16 is fixedly mounted at its lower end 31 to shaft end section 30. In a more preferred embodiment also fixedly mounted to the staff 16 or to the shaft end section 30 is stop bar 32. As illustrated in Photographs 5-7, extending perpendicularly from stop bar 32 is a shaft 33 having ball element 34 affixed to its extending end to which a ball socket 35 (such as one extending from one end of the tensioning assembly 22) can be operatively attached. Affixed to support plate top surface 25 in the rotation path of stop bar 32 is stop member 36 that limits the degree of rotation of shaft 27 so that staff 16 is positioned perpendicular to the support plate top surface 25 when derail 2 is in operative position. In an alternative embodiment stop member 36 could be placed in the rotation path of staff 16. This embodiment would eliminate the need for stop bar 32, but may cause damage to staff 16 unless staff 16 is constructed to withstand the force of striking stop bar 32 when derail 2 is manipulated into the derailing position.

Because prior art derails can be manipulated with one hand it is possible for a person to accidentally cause the derail 2 to be maneuvered into an operational derailing position. To minimize or prevent this from happening it is preferred that a blue flag staff lock-out device 76 be affixed to support plate 19 at a position to be activated when the blue flag staff 16 passes device 76 during its movement from a vertical position to a horizontal position. A particularly preferred lock-out device 76 is constructed having a hollow body 77 provided with a horizontally oriented passageway 78 into which spring 79 and lock activation member 80 are positioned. Passageway 78 is formed by the back wall 81, top wall 82, spacer wall 83, front wall 84 having a slot 85 sized to permit tongue section 86 of lock activation member 80 to move in and out of slot 85, and parallel side walls 86. In this embodiment lock activation member 80 is constructed having a shoulder stop section 88 as well as the an activation tongue section 87 that is positioned into the pathway of the blue flag staff 16 by the force exerted by spring 79 pushing against the back surface 89 of shoulder stop section 88. Activation tongue section 87 has a downwardly sloped surface 90 that will be struck when blue flag staff 16 moves from its vertical to its horizontal position. The slope of surface 90 is set to permit blue flag staff 16 to cause tongue section 87 to compress spring 79 as it moves back into passageway 78 a sufficient distance to allow blue flag staff 16 to pass below tongue section 87. Body 77 will be of sufficient height to permit tongue section 87 to extend outward and over the blue flag staff 16 when the blue flag staff 16 is in its horizontal position. In this position tongue section 87 prohibits blue flag staff 16 from being raised from its horizontal position to its vertical position. To permit blue flag staff 16 to be raised requires the person with one hand to push tongue section 87 back into passageway 78 while with the other hand manipulating derail activation handle 13. Requiring the operator two utilize both hands to change the derail 2 from a non-operative position to an operative, derail position minimizes the likelihood that the derail 2 will be accidentally activated. In a more preferred embodiment the top wall 82 of body 77 is spot welded or otherwise attached to body 77 to allow it to be separated from body 77 before body 77 would be pried from support plate 19 or before blue flag staff 16 would be bent when blue flag staff 16 pushes against tongue section 87 when derail 2 is activated and the operator has not pushed tongue section 87 back into passageway 78.

Tensioning assembly 22 is structured to apply pressure against the blue flag staff 16 to minimize movement of the blue flag staff 16 in the horizontal position to prevent inadvertent movement toward the vertical position. The amount of tension is preferably sufficient to cause a break in the linkage assembly 4 before the blue flag staff 16 would inadvertently cause the blue flag staff 16 to be moved to the vertical position. There are many known devices that can create such a resisting force to be applied to a surface. These would include various hydraulically or engine driven piston assemblies. However, a preferred tensioning assembly is illustrated in Photographs 5-7 and 11. This preferred tensioning assembly 22 includes a main cylinder 37 having a cavity 38 closed at one end 39 by ball socket support shaft 40 having a socket member 41 affixed to the extending end 42 of shaft 40 to operatively receive a ball member such as one forming a part of cam assembly 23. It also includes a piston 43 sized to extend partially into cavity 38. Piston 43 and the wall 44 forming cavity 38 are provided with stop means to limit the distance that piston 43 can slide back and forth within cavity 38. There are many known stop means that can accomplish this objective and can be used in tensioning assembly 22. A preferred stop means includes a protrusion, such as roll pin 45, extending perpendicularly from piston 43. In this preferred embodiment a slot 46 is formed in main cylinder 34 extending into cavity 35. Roll pin 45 is inserted into slot 46 thus limiting the distance that piston 43 can slide to the length of slot 46.

Shaft 47 is attached to and extends from one end section 48 of piston 43. Attached at the opposite end of shaft 47 is ball socket 35 that is operatively attached to ball element 34. Positioned within cavity 38 between closed end 39 and piston 43 is spring 49 that is sized and shaped to exert pressure against both closed end 39 and piston 43. To provide the desired tensioning effect it is preferred that a ⅞″ valve spring 44 be utilized.

The cam assembly 23 includes an upper cam plate 50 provided with a post 51 extending perpendicularly from upper cam plate 50 preferably from at one end section 52 of upper cam plate 50. Post 51 has at its extending end ball element 53 that can be operatively attached to socket member 41. At its opposite end section 54 upper cam plate 50 is provided with an opening 55 to receive cam shaft 56. Extending perpendicularly below opening 55 is a tubular sleeve 57 through which shaft 56 extends. It is preferred that tubular sleeve 57 extend at least one inch below support plate 19 to better achieve the “lock out” function of the linkage assembly 4. Tubular sleeve 57 supports upper cam plate 50 above the support plate top surface 25 a predetermined distance to permit the unobstructed movement of the tensioning assembly 22 during the activation/deactivation procedure. In a preferred embodiment tubular sleeve 57 also extends below support plate bottom surface 58 and is affixed to lower cam plate 59 to support lower cam plate 59 at a predetermined distance to permit the unobstructed movement of the linkage arm 6 during the activation/deactivation procedure and to allow linkage arm 6 to be bent to better achieve the “lock out” function of the linkage assembly 4. Cam shaft 56 extends through an opening 60 in one end section 61 of the lower cam plate 59. At the opposite end section 62 of lower cam plate 59 is a post 63 having a ball element 64 positioned shaped to operatively connect to a ball socket 65 of linkage arm 6. In a preferred embodiment as illustrated in Drawings 1-2 utilizing the vertical axis of the cam shaft 56 as the vortex the angle foamed by the upper cam plate 50 and the lower cam plate 59 is between 95°-115°, and more preferably about 105°.

Linkage arm 6 is provided with ball sockets 65 and 66 affixed at the opposite end sections 67 and 68, respectively, of linkage arm 6. As illustrated in Photographs 8-9, derail shoe detachment member 5 is provided with a shaft 69 extending horizontally from detachment member 5. At the extending end 70 of shaft 69 is a ball element 71 shaped to operatively receive linkage arm socket 66 to allow pivoting and rotation motion of linkage arm 6 relevant to derail shoe 8.

Other preferred embodiments of this invention include providing grease fitting 72 to lubricate cam assembly tubular sleeve 57 and grease fitting 73 to lubricate blue flag mounting structure 20. It is also preferred that if blue flag staff 16 is constructed from hollow tubing that has weep hole 74 positioned at the staff base section 75 to allow water that may get in the hollow tubing to drain from the tubing.

Other embodiments of the invention are obvious from the descriptions of the features of the invention described herein, and are intended to be included within the scope of the invention defined by the following claims.

What I claim is:

1. A linkage assembly for operatively connecting a derail being affixed to adjacent cross ties of a train track and having the derail operatively positional on top of one of the parallel rails of the train track to a blue flag signal to allow the blue flag signal to be positioned vertically perpendicular to the train track when the derail is in operative position to derail a wheeled vehicle moving on the train track and to allow the blue flag assembly to be horizontally positioned between the parallel rails when the derail is in an in-operative position that will not cause a wheeled vehicle moving on the train tracks to derail, the linkage assembly comprising:
a. a support plate mountable between the parallel rails and on adjacent cross ties of the train track,
b. a blue flag pivot mounting assembly comprising:
i. a sleeve member affixed to the support plate and having a passageway extending there though along its center longitudinal axis,
ii. a shaft sized to rotate within the passageway, the shaft having a flanged end abutting one end of the sleeve member to prevent or reduce water or other matter from entering the passageway, the shaft having a length whereby its opposite extends sufficiently beyond the sleeve member to permit the attachment of the blue flag
iii. a stop member affixed to the support plate or to the blue flag signal at a position to prevent the blue flag signal from pivoting beyond its vertical position perpendicular to the support plate;
c. a tensioning assembly operatively connected at one end to the blue flag signal to apply a force against the blue flag signal;
d. a cam assembly affixed to the support plate, the cam assembly comprising:
i. a first cam aim positioned above the support plate and operatively connected at one end section to the opposite end of the tensioning assembly
ii. a second cam aim positioned below the support plate,
iii. a cam sleeve extending vertically through an opening in the support plate and having a passageway along its center longitudinal axis,
iv. a cam axle rotatably positioned in the cam sleeve passageway and affixed at one end to the opposite end section of the first cam arm and affixed at its opposite end to one end section of the second cam aim whereby the first and second cam aims abut the ends of the cam sleeve above and below the support plate, respectively,
e. a linkage aim operatively connected at one end section to the opposite end section of the second cam aim and at its opposite end section to the derail, the linkage arm shaped to require a force to move the derail into a force required to break the linkage assembly.

2. A linkage assembly according to claim 1 wherein a grease fitting is operatively fixed to the sleeve to permit applying grease or other lubricant into the sleeve passageway between an interior passageway wall and the shaft.

3. A linkage assembly according to claim 1 wherein the tensioning assembly comprises:
a. a main cylinder having a cavity closed at one end,
b. a piston having a first end section that is sized and positioned to slide into the cylinder cavity and a second end section positioned to extend outside the main cylinder cavity,
c. a stop member affixed to the piston and positioned within the main cylinder cavity so as to limit the distance that the piston can slide within the main cylinder, and
d. a spring positioned in the cylinder cavity between the cavity closed end and the piston first end section, the spring sized and shaped to exert pressure on the cavity closed end and the piston first end section.

4. A linkage assembly according to claim 3 wherein a first ball joint member is affixed to the piston first end section for operative connection to the blue flag pivot mounting assembly and a second ball joint member is affixed to the piston second end section for operative connection to the first cam arm.

5. A linkage assembly according to claim 1 wherein the angle formed by the first cam arm and the second cam arm about the cam axle is about 95°-115°.

6. A linkage assembly according to claim 1 wherein a cam grease fitting is operatively affixed to the cam sleeve to permit grease or other lubricant to be forced into cam sleeve passageway between the cam axle and a cam sleeve interior wall surface.

7. A linkage assembly according to claim 1 wherein the first end section of the linkage arm is positioned to extend below the location of its connection point with the derail and its opposite end section is bent upward to be positioned at the connection point.

8. A linkage assembly according to claim 7 wherein the opposite end section is bent about 75° to 90°.

9. A derail and blue flag signal assembly comprising
a. a derail for derailing a wheel of a wheeled railed vehicle, the derail being mounted on railroad ties and being electively positioned adjacent one rail for accomplishing the derailing, the derail comprising:
i. a base rigidly secured to the rail ties,
ii. a derail shoe pivotally mounted on the base for movement between an operative, derailing position and an inoperative position, the derail shoe having a derail member positioned on said rail when in the operative position on the rail for deflecting the wheel from rolling on the rail and for thereby derailing the wheeled vehicle,
b. a blue flag signal comprising:
i. a sign and
ii. a staff, the sign mounted at one end of the staff,
c. a linkage assembly comprising:
i. a support plate mountable between the parallel rails and on adjacent cross ties of the train track,
ii. a blue flag pivot mounting assembly comprising a sleeve member affixed to the support plate and having a passageway extending there though along its center longitudinal axis, a shaft sized to rotate within the passageway, the shaft having a flanged end abutting one end of the sleeve member to prevent or reduce water or other matter from entering the passageway, the shaft having a length whereby its opposite extends sufficiently beyond the sleeve member to permit the attachment of the blue flag signal staff, and a stop member affixed to the support plate or to the blue flag signal at a position to prevent the blue flag signal from pivoting beyond its vertical position perpendicular to the support plate;
iii. a tensioning assembly operatively connected at one end to the blue flag signal to apply a force against the blue flag signal;
iv. a cam assembly affixed to the support plate, the cam assembly comprising a first cam arm positioned above the support plate and operatively connected at one end section to the opposite end of the tensioning assembly, a second cam arm positioned below the support plate, a cam sleeve extending vertically through an opening in the support plate and having a passageway along its center longitudinal axis, a cam axle positioned in the cam sleeve passageway and sized to permit the cam axle to rotate within the passageway and affixed at one end to the opposite end section of the first cam arm and affixed at its opposite end to one end section of the second cam arm whereby the first and second cam arms abut the ends of the cam sleeve above and below the support plate, respectively,
v. a linkage aim operatively connected at one end section to the opposite end section of the second cam arm and at its opposite end section to the derail, the linkage arm shaped to require a force to move the derail into a derailing position by the lifting of the blue flag signal be greater than the force required to break the linkage assembly.

10. A derail and blue flag signal assembly according to claim 9 wherein:
a. the angle faulted by the first cam arm and the second cam arm about the cam axle is about 95°-115°;
b. the first end section of the linkage arm is positioned to extend below the location of its connection point with the derail and its opposite end section is bent upward about 75° to 90° degrees to be positioned at the connection point.

11. A derail and blue flag signal assembly according to
claim 9 further comprising a blue flag staff locking device affixed to the support plate to operatively engage the blue flag as it moves from its vertical position to a horizontal position when the derail is in the inoperative position.

12. A derail and blue flag signal assembly according to
claim 11 wherein said blue flag staff locking device comprises a hollow body affixed to the support plate and provided with a passageway housing in its rear portion a spring that exerts a force against a lock activation member having a tongue section extending out of the passageway, the tongue section have a downwardly sloped surface which when extending out of the passageway extends into the path of the blue flag staff moving from its vertical position to the horizontal position.

13. A derail and blue flag signal assembly according to claim 12 wherein the hollow body comprises a top wall that will be pried from the hollow body before the hollow body will be pried from the support plate by the force of the blue flag staff against the tongue section as the blue flag staff is moved from the horizontal position to its vertical position.
